(19) United States
(12) Patent Application Publication
(10) Pub. No.: US 2017/0102602 A1
(43) Pub. Date: Apr. 13, 2017

(54) METHOD FOR DRIVING ELECTROCHROMIC DEVICE

(71) Applicant: TINTABLE KIBING CO., LTD., TAINAN CITY (TW)

(72) Inventor: YI-WEN CHUNG, TAINAN CITY (TW)

(21) Appl. No.: 14/878,149

(22) Filed: Oct. 8, 2015

(51) Int. Cl. G02F 1/163

(52) U.S. Cl. CPC G02F 1/163

(57) ABSTRACT

A method for driving electrochromic devices is revealed. The voltage that drives an electrochromic device is changed according to signals (such as temperature, time, quantity of electricity, current, etc) detected during coloration of the electrochromic device. The control mechanism of the present invention drives the electrochromic device by different voltages in multiple stages. During repetitive control of the coloration of the electrochromic device, the coloration of the electrochromic device becomes more uniform, the coloration time is shortened, and the service life is extended.

### BACKGROUND OF THE INVENTION

Field of the Invention

The present invention relates to a method for driving electrochromic devices, especially to a method for driving electrochromic devices that makes coloration of the electrochromic device more uniform, shortens the coloration time, and prolongs the service life of the electrochromic device.

Descriptions of Related Art

Electrochromic materials are materials that exhibit a reversible color change induced by application of an electric field. Electrochromic materials exhibit significant, reversible optical absorption at visible wavelengths by a redox reaction. The oxidized and reduced forms of the electrochromic materials have different colors. The electrochromic device made from electrochromic materials controls the optical properties such as optical transmission and optical absorption by application of a voltage. When an external voltage is applied, the electrochromic device is colored. Once the external voltage is shut off, the ions slowly leave the electrochromic layer by diffusion and the electrochromic device is in a bleached state. The coloured/bleached efficiency of the electrochromic device depends on the diffusion rate of the ions in the electrochromic layer.

Generally, a higher voltage provided speeds up the coloration of the electrochromic layer. Yet the failure rate of the electrochromic device is increased when a sudden high voltage is applied. Thus the present invention focuses on the control of the voltage applied that not only makes the electrochromic device become coloured quickly but also prolongs service life of the electrochromic device.

### SUMMARY OF THE INVENTION

Therefore it is a primary object of the present invention to provide a method for driving electrochromic devices that not only makes coloration of the electrochromic device more uniform but also shortens coloration time, and extends the service life of the electrochromic device.

In order to achieve the above object, a method for driving electrochromic devices according to the present invention includes the following steps.

S1: Start coloration. Apply a coloration voltage to an electrochromic device so that the electrochromic device begins to color.

S2: Detect the electrochromic device to get at least one signal. The electrochromic device is detected and a signal corresponding to the detected state is obtained during the coloration of the electrochromic device.

S3: Send the signal back to get a coloration voltage. The signal corresponding to the detected state is sent back to a controller. Then the controller processes the signal and generates a new coloration voltage corresponding to the signal accordingly.

S4: Supply the new coloration voltage. The new coloration voltage obtained is provided to the electrochromic device so that the electrochromic device continues the coloration.

S5: Check whether the coloration is completed. The flow chart mentioned above is stopped if the coloration of the electrochromic device is completed. Or turn back to the step S2 if the coloration of the electrochromic device is still not completed.

In the step S2 of detecting the electrochromic device to get at least one signal, an ambient temperature around the electrochromic device is detected to get a signal corresponding to the detected state.

In the step S2 of detecting the electrochromic device to get at least one signal, coloration time of the electrochromic device is detected to get a signal corresponding to the detected state.

In the step S2 of detecting the electrochromic device to get at least one signal, a quantity of electricity in the electrochromic device is detected to get a signal corresponding to the detected state.

In the step S2 of detecting the electrochromic device to get at least one signal, a current in the electrochromic device is detected to get a signal corresponding to the detected state.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a flow chart showing steps of an embodiment according to the present invention;

FIG. 2 is a drive voltage versus ambient temperature curve of an embodiment in which an ambient temperature around an electrochromic device is detected according to the present invention;

FIG. 3 is a drive voltage versus coloration time of an embodiment in which coloration time of an electrochromic device is detected according to the present invention;

FIG. 4 is a drive voltage versus electric quantity curve of an embodiment in which a quantity of electricity of an electrochromic device is detected according to the present invention;

FIG. 5 is a drive voltage versus current curve of an embodiment in which a current of an electrochromic device is detected according to the present invention.

### DETAILED DESCRIPTION OF THE PREFFERED EMBODIMENT

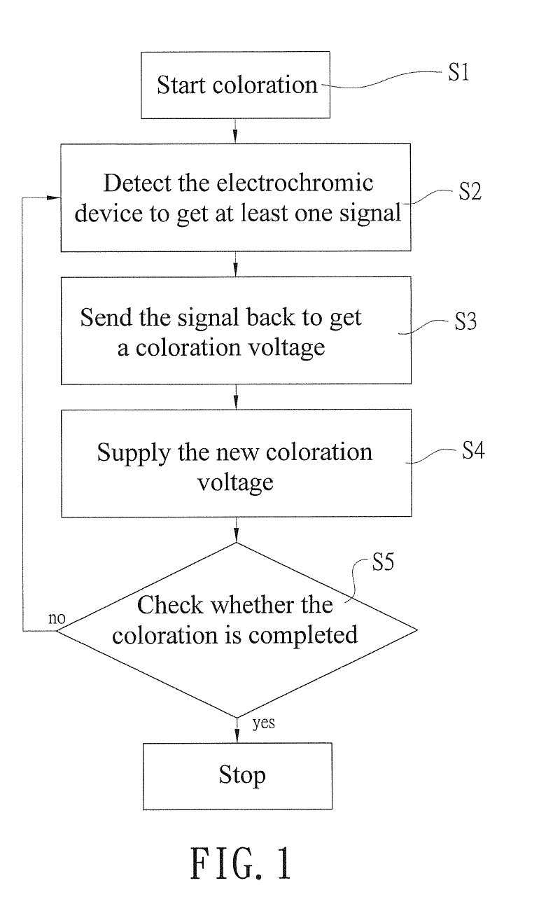

Refer to FIG. 1, a flow chart showing steps of a method for driving electrochromic devices according to the present invention is revealed.

The method for driving electrochromic devices according to the present invention includes the following steps.

S1: Start coloration. Apply a coloration voltage to an electrochromic device so that the electrochromic device begins to color.

S2: Detect the electrochromic device to get at least one signal. The electrochromic device is detected and a signal corresponding to the detected state is obtained during the coloration of the electrochromic device.

S3: Send the signal back to get a coloration voltage. The signal corresponding to the detected state is sent back to a controller. Then the controller processes the signal and generates a new coloration voltage corresponding to the signal accordingly.

S4: Supply the new coloration voltage. The new coloration voltage generated is provided to the electrochromic device so that the electrochromic device continues the coloration.

S5: Check whether the coloration is completed. The flow chart mentioned above is stopped once the coloration of the electrochromic device is completed. Or turn back to the step S2 if the coloration of the electrochromic device is still not completed.

The above steps not only speed up the coloration of the electrochromic device but also make the colored state of the electrochromic device become more uniform and extend service life of the electrochromic device.

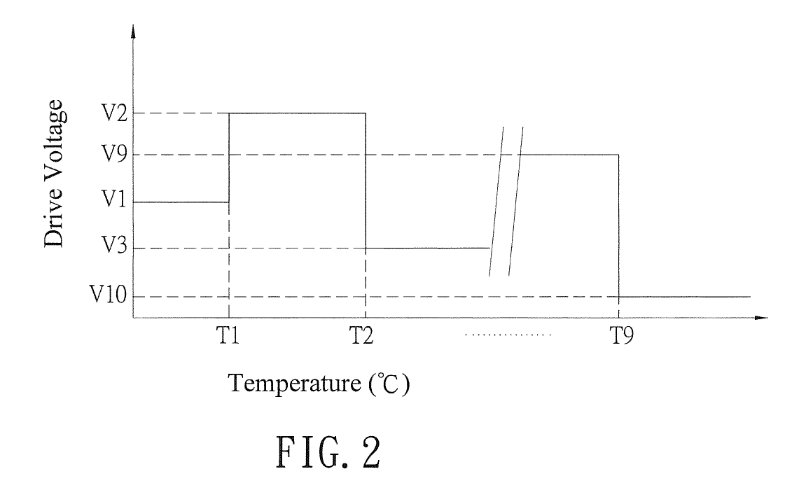

Refer to FIG. 2, a drive voltage versus ambient temperature curve of an embodiment is revealed. An ambient temperature of an electrochromic device is detected in the step S2 of an embodiment of the present invention. Firstly apply a V1 coloration voltage to the electrochromic device so that the electrochromic device starts coloration. During the coloration, the ambient temperature around the electrochromic device (environmental temperature) is detected at any time and a T1 temperature signal is obtained. The temperature signal T1 obtained is sent to the controller. After processing of the signal, a V2 coloration voltage corresponding to the T1 temperature signal is output and provided to the electrochromic device. Then the electrochromic device carries out the coloration according to the input V2 coloration voltage. During the coloration, the environmental temperature surrounding the electrochromic device is still detected synchronously and a T2 temperature signal is obtained. Then the T2 temperature signal is sent to the controller and analyzed by the controller so as to output a V3 coloration voltage corresponding to the T2 temperature signal. Next the V3 coloration voltage is provided to the electrochromic device and the electrochromic device carries out the coloration according to the input V3 coloration voltage. By repeating the above steps, the time required for coloration of the electrochromic device is reduced and the service life of the electrochromic device is prolonged under the condition that the coloration of the electrochromic device is completely quickly.

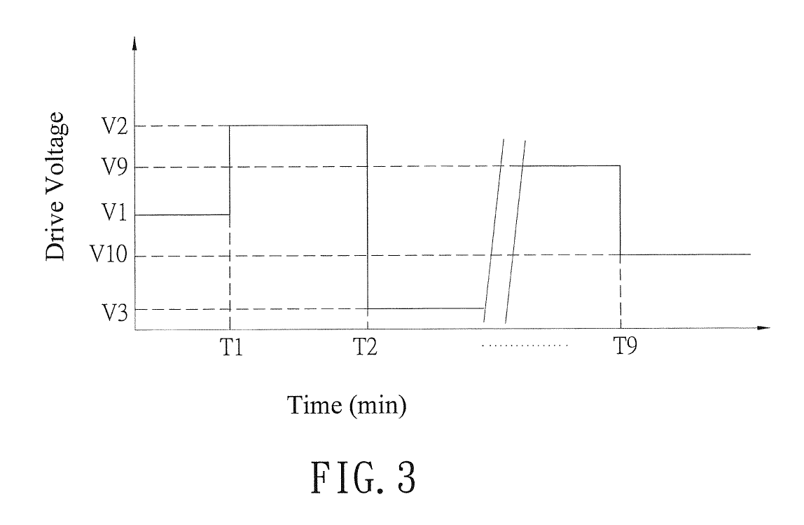

Refer to FIG. 3, a drive voltage versus coloration time curve of an embodiment is revealed. The coloration time of an electrochromic device is detected in the step S2 of an embodiment of the present invention. At first apply a V1 coloration voltage to the electrochromic device so that coloration of the electrochromic device takes place. During the coloration, a T1 time signal is generated once the time T1 is up and the T1 time signal is sent to the controller. After the T1 time signal being processed by the controller, a V2 coloration voltage corresponding to the T1 time signal is output and provided to the electrochromic device by the controller. Then the electrochromic device continues the coloration according to the V2 coloration voltage input. During this coloration, a T2 time signal is generated once the time T2 is up. Then the T2 time signal is sent to and processed by the controller so that the controller outputs a V3 coloration voltage corresponding to the T2 time signal. Next the V3 coloration voltage is supplied to the electrochromic device and the electrochromic device performs the coloration according to the input V3 coloration voltage. Then repeat the steps mentioned above.

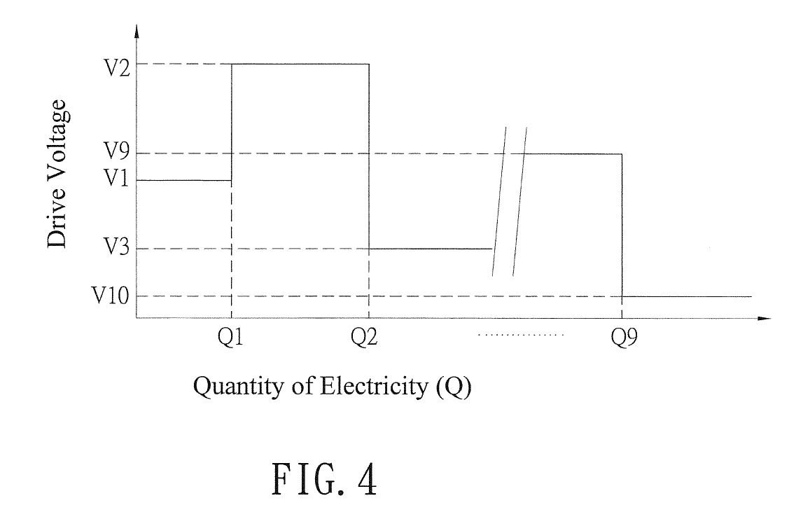

Refer to FIG. 4, a drive voltage versus electric quantity curve of an embodiment is revealed. A quantity of electricity inside an electrochromic device is detected in the step S2 of an embodiment of the present invention. In the beginning, apply a V1 coloration voltage to the electrochromic device so that coloration of the electrochromic device occurs. During the coloration, the quantity of electricity inside the electrochromic device is detected at all times and a Q1 electric quantity signal is obtained. The Q1 electric quantity signal detected is sent to the controller. Then the controller processes the Q1 electric quantity signal and outputs a V2 coloration voltage corresponding to the Q1 electric quantity signal. Next the V2 coloration voltage is provided to the electrochromic device so that the electrochromic device carries out the coloration according to the V2 coloration voltage input. During the coloration, the quantity of electricity in the electrochromic device is still detected synchronously to get a Q2 electric quantity signal. Then the Q2 electric quantity signal is delivered to the controller and processed by the controller so that the controller outputs a V3 coloration voltage corresponding to the Q2 electric quantity signal. Next the V3 coloration voltage is supplied to the electrochromic device and the electrochromic device performs the coloration according to the input V3 coloration voltage. The electrochromic device can be colored quickly by repetitive running of the above steps.

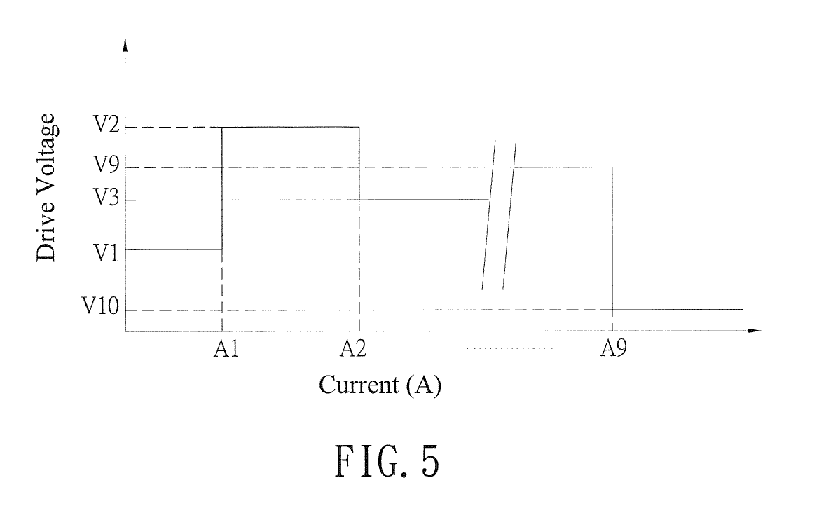

Refer to FIG. 5, a drive voltage versus current curve of an embodiment is revealed. A current inside an electrochromic device is detected in the step S2 of an embodiment of the present invention. Firstly apply a V1 coloration voltage to the electrochromic device so that coloration of the electrochromic device occurs. During the coloration, the current in the electrochromic device is constantly detected and an Al current signal is obtained. The A1 current signal is sent to the controller. After the A1 current signal being processed by the controller, a V2 coloration voltage correspondingly to the A1 current signal is output by the controller and supplied to the electrochromic device. Then the coloration of the electrochromic device takes places according to the V2 coloration voltage. During the electrochromic coloration, the current in the electrochromic device is still detected synchronously to get an A2 current signal and give the A2 current signal to the controller. The controller processes the A2 current signal and outputs a V3 coloration voltage to the electrochromic device while the V3 coloration voltage is corresponding to the A2 current signal. Then coloration of the electrochromic device occurs according to the V3 coloration voltage input. By running the steps mentioned above, the electrochromic device is colored quickly.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A method for driving electrochromic devices comprising the steps of:
S1: starting coloration; applying a coloration voltage to an electrochromic device so that the electrochromic device starts coloration;
S2: detecting the electrochromic device to get at least one signal; detecting the electrochromic device to get a signal corresponding to the detected state during the coloration of the electrochromic device;
S3: sending the signal back to get a coloration voltage; sending the signal corresponding to the detected state back to a controller and then the controller processes the signal to get a new coloration voltage corresponding to the signal;
S4: supplying the new coloration voltage; providing the new coloration voltage generated to the electrochromic device so that the electrochromic device continues the coloration.
S5: checking whether the coloration is completed; stopping a flow chart of the steps once the coloration of the electrochromic device is completed; turning back to the step S2 if the coloration of the electrochromic device is still not completed.

2. The method as claimed in claim 1, wherein an ambient temperature around the electrochromic device is detected in the step S2 of detecting the electrochromic device to get at least one signal.

3. The method as claimed in claim 1, wherein coloration time of the electrochromic device is detected in the step S2 of detecting the electrochromic device to get at least one signal.

4. The method as claimed in claim 1, wherein a quantity of electricity in the electrochromic device is detected in the step S2 of detecting the electrochromic device to get at least one signal.

5. The method as claimed in claim 1, wherein a current in the electrochromic device is detected in the step S2 of detecting the electrochromic device to get at least one signal.
